(19) United States
(12) Patent Application Publication
(10) Pub. No.: US 2026/0025652 A1
(43) Pub. Date: Jan. 22, 2026

(54) INITIAL CONTROL FRAME FOR UNAVAILABILITY FOR WIRELESS NETWORK

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/251,679

(22) Filed: Jun. 26, 2025

Related U.S. Application Data
(60) Provisional application No. 63/674,052, filed on Jul. 22, 2024.
(60) Provisional application No. 63/761,704, filed on Feb. 21, 2025.

(51) Int. Cl. H04W 8/24; H04W 28/02; H04W 84/12

(52) U.S. Cl. CPC H04W 8/24; H04W 28/0278; H04W 84/12

(57) ABSTRACT

A station (STA) in a wireless network includes a memory and a processor coupled to the memory, the processor is to cause receiving, from an access point (AP), an initial control frame (ICF) that solicits an initial control response (ICR) frame including unavailability information, the ICF including a field indicating a format of the ICR frame and transmitting, to the AP, the ICR frame including unavailability information, the format of the ICR frame being determined based on the field indicating the format of the ICR frame in response to the ICF.

### CROSS-REFERENCE TO RELATED APPLICATION(S)

This application claims the benefit of priority from U.S. Provisional Application No. 63/674,052, entitled “INITIAL CONTROL FRAME DESIGN FOR CO-EXISTENCE OPERATION IN NEXT GENERATION WLANS,” filed Jul. 22, 2024; and U.S. Provisional Application No. 63/761,704, entitled “INITIAL CONTROL FRAME DESIGN FOR CO-EXISTENCE OPERATION IN NEXT GENERATION WLANS,” filed Feb. 21, 2025, all of which are incorporated herein by reference in their entirety.

### TECHNICAL FIELD

This disclosure relates generally to a wireless communication system, and more particularly to, for example, but not limited to, an initial control frame for unavailability operation in a wireless network.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

While WLAN has been evolving, other technologies have also emerged and continued to grow in various markets such as home and enterprise. Some examples include short range personal area network (PAN) or wireless personal area network (WPAN). For example, Bluetooth is a short-range wireless technology used to connect devices enabling data to be exchanged. In other examples, the WPAN could be an example of a Zigbee network or technology. In at least one example, Zigbee refers to a standards-based wireless mesh network—e.g., used to create personal area networks with small low-powered digital radios. Additionally, ultra-wideband (UWB) is emerging as a radio technology that can use a lower energy level for high-bandwidth communications. Some examples of UWB applications include data collection, precise locating, and tracking. These and other technologies can operate on protocols different than the WLAN networks—e.g., operate with protocols not compliant with WLAN. However, some of the technologies share similar channel usage, a same frequency band, and/or interfere with the WLAN network. In other examples, some devices can include multiple radio technologies and each one may use a same antenna in the device—e.g., a device can use a same antenna for Wi-Fi and Bluetooth. As these technologies grow, their potential interference problem with subsequent Wi-Fi generations worsens.

Once approach to address this concern is to reduce a transmit opportunity (TXOP) dynamically such that the TXOP ends prior to a start of a co-existence event (e.g., start of the interference from the co-existing technology). By reducing the TXOP, a transmitting device (e.g., AP or STA) can transmit an initial control frame (ICF) and a responding device (e.g., AP or STA) can transmit an initial control response (ICR) frame. However, designing new ICF and ICR frames can lead to heavy implementation change and yet current ICF and ICR frames do not provide a mechanism to exchange co-existence information. Accordingly, a mechanism or design is needed for exchanging ICF and ICR frames after reducing a TXOP for co-existence (e.g., unavailability) operations.

The description set forth in the background section should not be assumed to be prior art merely because it is set forth in the background section. The background section may describe aspects or embodiments of the present disclosure.

### SUMMARY

An aspect of the present disclosure provides for a station in a wireless network including a memory and a processor coupled to the memory, the processor to cause receiving, from an access point (AP), an initial control frame (ICF) that solicits an initial control response (ICR) frame including unavailability information, the ICF including a field indicating a format of the ICR frame and transmitting, to the AP, the ICR frame including unavailability information, the format of the ICR frame being determined based on the field indicating the format of the ICR frame in response to the ICF.

In an embodiment, the ICF is a buffer status report poll (BSRP) trigger frame.

In an embodiment, the ICR frame is a multi-STA block acknowledgment (BA) frame.

In an embodiment, the multi-STA BA frame includes the unavailability information and a buffer status report of the STA.

In an embodiment, the processor is to cause the transmitting the multi-STA BA frame including the unavailability information and the buffer status report of the STA based on an unavailability session with the AP.

In an embodiment, the unavailability information is one or more of associated with in-device coexistence, timing information of the in-device coexistence, or frequency information of the in-device coexistence.

In an embodiment, the ICF includes a common information field and one or more user information fields, the common information field providing information that is common to one or more recipients, and each user information field providing information that is specific to a corresponding recipient, the field indicating the format of the ICR frame is included in the common information field, and a user information field includes an identifier that addresses the STA.

In an embodiment, the field having a first value indicates a first format of the ICR frame soliciting the unavailability information and the field having a second value indicates a second format of the ICR soliciting a buffer status report of the STA.

An aspect of the present disclosure provides for an access point (AP) in a wireless network including a memory and a processor coupled to the memory, the processor to cause transmitting, to one or more stations (STAs), an initial control frame (ICF) that solicits one or more initial control response (ICR) frames including unavailability information, the ICF including a field indicating a format of the one or more ICR frames and receiving, from at least one STA, an ICR frame including unavailability information, the format of the ICR frame being determined based on the field indicating the format of the ICR frame in response to the ICF.

In an embodiment, the ICF is a buffer status report poll (BSRP) trigger frame.

In an embodiment, the ICR frame is a multi-STA block acknowledgment agreement (BA) frame.

In an embodiment, the multi-STA BA frame includes the unavailability information and a buffer status report of the at least one STA.

In an embodiment, the processor is to cause the receiving the multi-STA BA frame including the unavailability information and the buffer status report of the at least one STA based on an unavailability session with the AP.

In an embodiment, the unavailability information is one or more of associated with in-device coexistence, timing information of the in-device coexistence, or frequency information of the in-device coexistence.

In an embodiment, the ICF includes a common information field and one or more user information fields, the common information field providing information that is common to the one or more STAs, and each user information field providing information that is specific to a corresponding STA of the one or more STAs, the field indicating the format of the ICR frame is included in the common information field, and each user information field includes an identifier that addresses the corresponding STA.

In an embodiment, the field having a first value indicates a first format of the ICR frame soliciting the unavailability information.

In an embodiment, the field having a second value indicates a second format of the ICR frame soliciting a buffer status report of the STA.

An aspect of the present disclosure provides for a method performed by a station (STA) in a wireless network including receiving, from an access point (AP), an initial control frame (ICF) that solicits an initial control response (ICR) frame including unavailability information, the ICF including a field indicating a format of the ICR frame and transmitting, to the AP, the ICR frame including unavailability information, the format of the ICR frame being determined based on the field indicating the format of the ICR frame in response to the ICF.

In an embodiment, the ICF is a buffer status report poll (BSRP) trigger frame.

In an embodiment, the ICR frame is a multi-STA block acknowledgment (BA) frame.

In an embodiment, the multi-STA BA frame includes the unavailability information and a buffer status report of the STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example ultra-wideband (UWB) system in accordance with an embodiment.

FIG. 5 shows an example illustration of a ZigBee mechanism in accordance with an embodiment.

FIG. 6 shows an example co-existence control frame exchange in accordance with an embodiment.

FIG. 7 shows an example co-existence control frame exchange in accordance with an embodiment.

FIG. 8 shows an example common information field including a co-existence indication in accordance with an embodiment.

FIG. 9 shows an example user information field including a co-existence indication in accordance with an embodiment.

FIG. 10 shows an example process for a control frame exchange for a co-existence operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

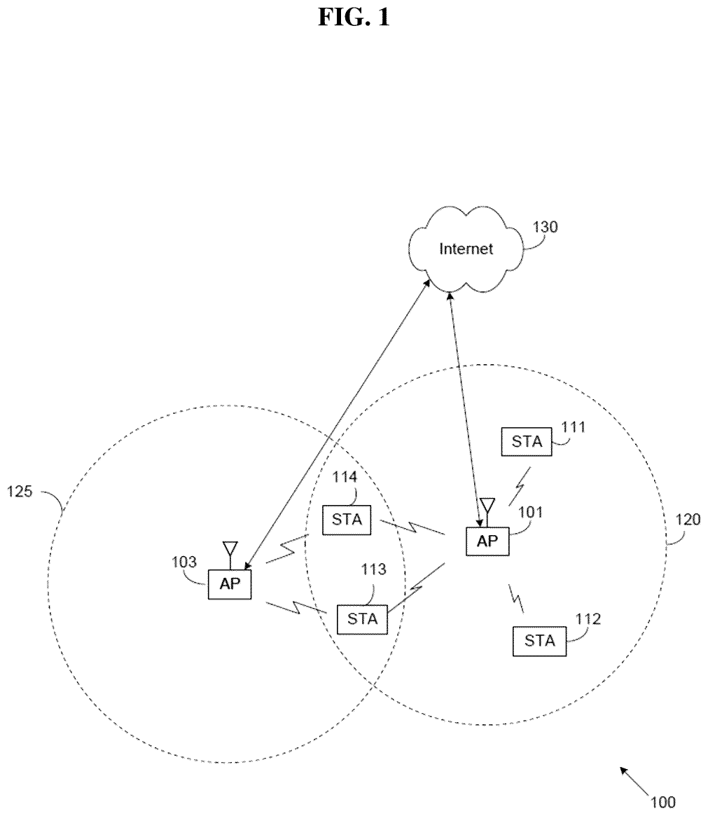

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

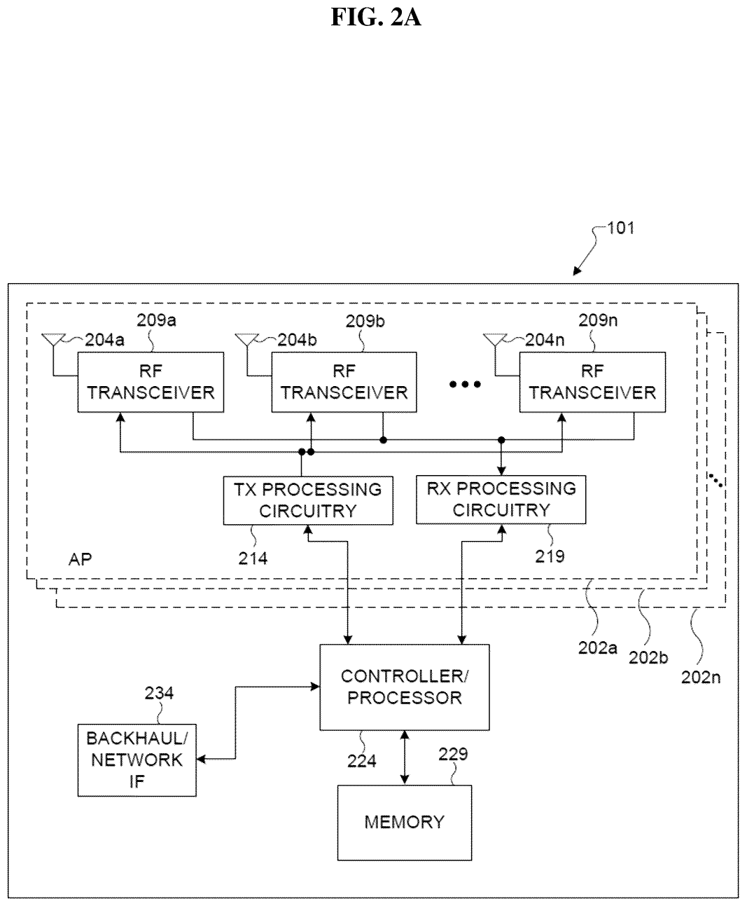

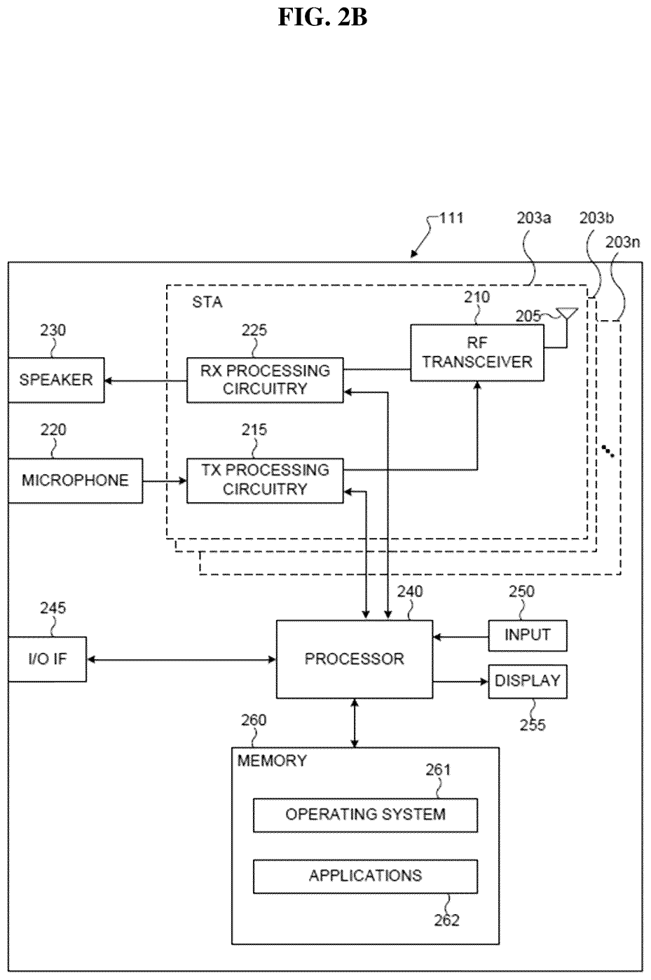

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

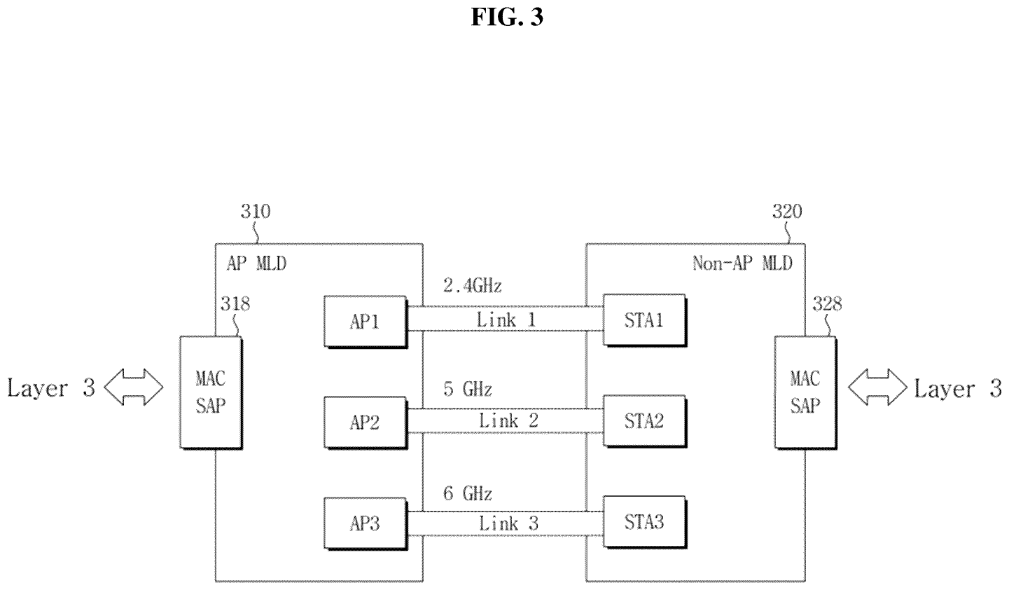

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link I which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11be D5.0, “Wireless LAN Medium Access Control (MAC) and Physical Layer (PHY) Specifications,” ii) IEEE Std 802.11-2020, “Wireless LAN Medium Access Control (MAC) and Physical Layer (PHY) Specifications,” and iii) IEEE Std 802.11ax-2021, “Wireless LAN Medium Access Control (MAC) and Physical Layer (PHY) Specifications.”

As mentioned above, technologies other than Wi-Fi are also emerging or growing. For example, Bluetooth is a wireless technology that initially started off as a short-distance cable replacement mechanism. In some examples, Bluetooth is a short-range wireless technology used to exchange data between devices. In one embodiment, Bluetooth implements ultra-high frequency (UHF) radio waves in at least an industrial, scientific, and medical (ISM) band from 2.402 gigahertz (GHz) to 2.48 GHz. In some embodiments, a Bluetooth transmission occurs as part of a connection event. For example, during the connection event, two devices (e.g., mobile or non-mobile devices, including but not limited to, smartphones, laptops, computers, headphones, ear plugs, TVs, a car stereo system, etc.) that are engaged in data transmission alternate sending data back and forth until all the data to be sent on both sides is exhausted. In some examples, one of the connected devices operates as a master and the other connected device operates as a slave. In such examples, the master device can transmit a frame (e.g., packet) to the salve device and if the slave device receives the frame, the slave device can transmit the frame back to the master device. In at least one embodiment, a connection interval refers to a duration between two connection events. In some embodiments, the connection interval can range from 7.5 milliseconds (ms) to 4 seconds (s). In at least one embodiment, an exact value of the connection duration can be negotiated between the master device and slave device to optimize their power saving while balancing latency occurred.

In some embodiments, Bluetooth transmission implements frequency hopping spread spectrum methods where a hopping sequence is used to rapidly hop between data channels. For example, Bluetooth classic is used for streaming applications (e.g., headsets) and operates on 79 radio frequency (RF) channels spaced 1 megahertz (MHz) apart. In such examples, the Bluetooth transmission can rapidly switch between multiple RF channels of the 79 RF channels. In some examples, Bluetooth Low Energy (BLE) is a power efficient variant of Bluetooth used for internet of things (IoT) applications. In some examples, the BLE operates on 40 RF channels each spaced 2 MHz apart. In at least one embodiment, for Bluetooth, some of the RF channels are reserved specifically for the purpose of advertising and others are used for secondary advertisement for data transmission. For example, Bluetooth classic includes 32 channels that are reserved for advertisement while BLE includes 3 channels that are reserved for advertisement.

However, Bluetooth and Wi-Fi follow different channel access protocols and the coexistence of Bluetooth can lead to interference with Wi-Fi transmissions. That is, while some Bluetooth transmissions are scheduled and make the interference more predictable, other Bluetooth transmissions are hard to predict in advance. Accordingly, a mechanism to react to Bluetooth interference when occurs is needed. Especially given that Bluetooth is used for a large number of applications today—e.g., used for streaming applications, sensor applications, way finding based on beaconing, etc. In some embodiments, Wi-Fi routers can include Bluetooth raidso for the purpose of finding and location awareness applications. Additionally, a user's smart phone can also be configured as a mobile AP which can utilize Bluetooth. It should be noted that while Bluetooth has primarily operated on the 2.4 GHz band, the next generation of Bluetooth technology is expected to utilize 5 GHz as well as 6 GHz bands. Thus, the interference could be worse for Wi-Fi devices or operations that utilize the 5 GHz and 6 GHz bands for communication.

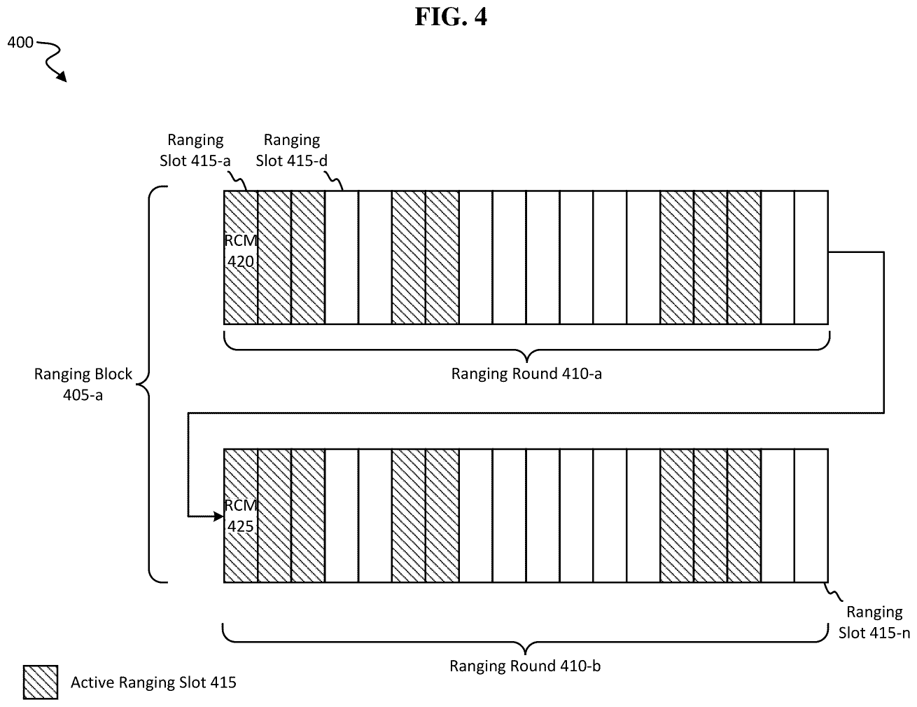

FIG. 4 shows an example scheme for an ultra-wide band (UWB) system 400. FIG. 4 illustrates a ranging block 405 in accordance with an embodiment. The ranging block 405 depicted in FIG. 4 is for explanatory and illustration purposes and FIG. 4 does not limit the scope of this disclosure to any particular implementation. In some embodiments, the ranging block 405 illustrated in FIG. 4 is used in conventional UWB solutions.

In at least one embodiment, ranging block 405 includes a ranging round 410-a and a ranging round 410-b. In at least one embodiment, each ranging round 410-a can include one or more ranging slots 415. In some embodiments, not all ranging slots 415 of the ranging round 410 are active—e.g., some ranging slots 415 are inactive and represent a silent period in which the system 400 is not transmitting data. For example, the system 400 can transmit data or frames during ranging slot 415-a to ranging slot 415-c and stop transmitting at ranging slot 415-d.

In at least one embodiment, UWB has become popular for use cases involving indoor positioning and navigation utilizing the 6 GHz band. In some embodiments, an IEEE 802.15.4 standard has defined a block-based mode for ranging. In the block-based mode for ranging, as depicted in FIG. 4, ranging blocks 405 is divided into ranging rounds 410 and the ranging rounds 410 are further divided into ranging slots 415. In some examples, a number of ranging rounds 410 in a ranging block 405, a number of ranging slots 415 in a ranging round 410, and a duration of each ranging slots 415 is transmitted by a controller in the system 400. In such examples, the controller can transmit the information in a ranging control message (RCM) 420 to a participant device. In some examples, the RCM 420 information is for a current ranging round 410. In other embodiments, the RCM 420 information can also be used for subsequent ranging rounds 410—e.g., the RCM 420 could also apply to the ranging round 410-b. It should be noted that although ranging round 410-a and ranging round 410bare depicted as having a same format, in other examples their format can vary. For example, ranging round 410bcan include less or more ranging rounds 410 and ranging slots 415 than compared with ranging round 410-a.

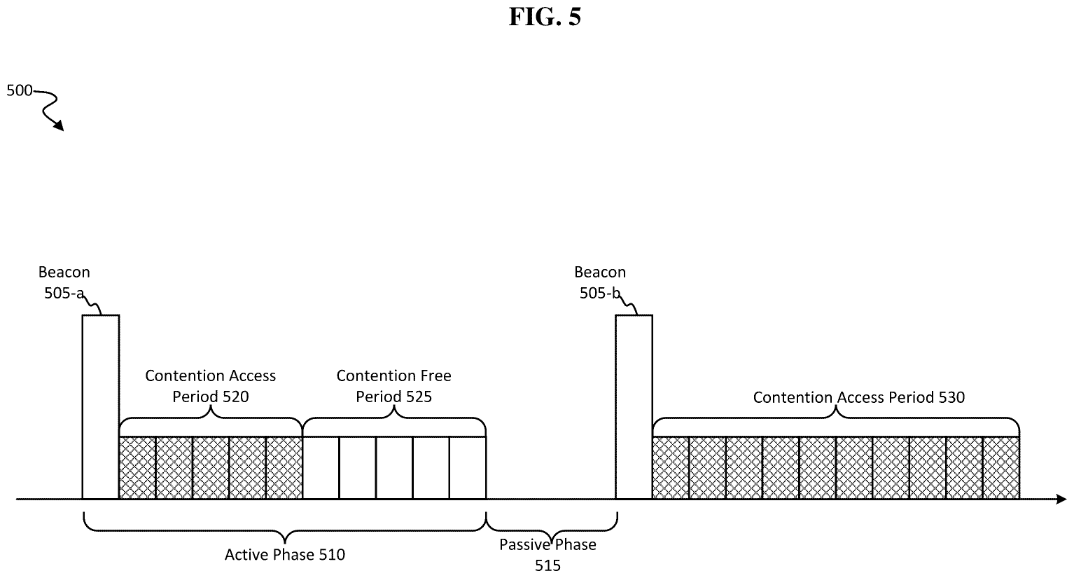

FIG. 5 illustrates an example scheme for a Zigbee system 500. FIG. 5 illustrates an access scheme for the Zigbee system 500. In some embodiments, the scheme for the Zigbee system 500 illustrated in FIG. 5 is used in conventional Zigbee solutions.

In at least one embodiment, Zigbee protocol is another technology for smart home applications. In at least one embodiment, the Zigbee protocol is based on beacon intervals—e.g., a duration between beacons 505. For example, a duration between transmitting beacon 505-a and transmitting beacon 505-b can be a first beacon interval. In some embodiments, a coordinator in ZigBee operation transmits periodic beacons 505. In such examples, each beacon 505 can be followed by the start of an active phase 510-e.g., the coordinator can transmit the beacon 505 to initiate the active phase 510. In at least one embodiment, each beacon 505 indicates a duration of the active phase 510 and a time until the next beacon frame 505. Accordingly, each beacon interval can be divided into two phases, a first phase includes the active phase 510 and starts after the beacon 505, and a second phase includes the passive phase 515 for power save. In some embodiments, the passive phase 515 can last from the end of the active phase 510 until a new beacon 505 is received. In at least one embodiment, the active phase 510 can be divided into a contention access period 520 and a contention free period 525. In at least one embodiment, a duration for each phase (e.g., for the active phase 510 or the inactive phase 515) and the beacon interval can be characterized by duration value (e.g., aBaseSlotDuration value), a beacon order (e.g., macBeaconOrder (BO)), and a frame order (e.g., macSuperframeOrder (SO)). In one example, the BO and SO values can be integer values ranging from 0 to 14. In at least one embodiment, the beacon interval can be computed as a duration (e.g., aBaseSuperframeDuration) times a multiple of two—e.g., Beacon Interval=aBaseSuperframeDuration*2^{BO}. In such embodiments, the active phase 515 can be computed as the duration times a multiple of two—e.g., Active Phase=aBaseSuperframeDuration*2^{SO}. In at least one embodiment, the duration (e.g., aBaseSuperframeDuration) is determined based on the duration of a slot—e.g., aBaseSuperframeDuration=16*aBaseSlotDuration.

In one embodiment, IEEE 802.11be introduced multi-link operations as a mean to enhance device performance. In such embodiments, a multi-link device (MLD) can include one or more stations (STAs) affiliated with it. Accordingly, an AP MLD can have one or more affiliated AP STAs with it and a non-AP MLD can have one or more non-AP STAs affiliated with it. During a multi-link operation, the AP MLD can transmit concurrently on more than one link. This can increase channel access probability but because multi-link operations (MLO) leverage the three bands of operation in Wi-Fi (e.g., 2.4 GHz, 5 GHz, 6 GHz), there can be coexistence interference.

In some examples, a mobile AP MLD is a special type of AP MLD. For example, the mobile AP MLD can be a battery powered device. In one example, the mobile AP MLD includes two links, a primary link and a non-primary link. However, mobile AP MLDS have additional constraints during their operations. For example mobile AP MLDs have a constraint of a tight synchronization between the transmission and reception on the primary and non-primary link. In one embodiment, an AP STA affiliated with the mobile AP MLD can initiate a physical layer protocol data unit (PPDU) transmission to its associated non-AP STA of the non-AP MLD on the non-primary link if the STA affiliated with the same MLD on the primary link is also initiating a PPDU as a transmission opportunity (TXOP) holder with a same start time. In at least one embodiment, the same constraint is also followed by the non-AP MLD side for a non-AP MLD associated with a Mobile AP MLD. In some embodiments, there can be coexistence interference for the mobile AP MLD.

In at least one embodiment, for a number of applications described above, one or more of non-Wi-Fi technology (e.g., non-IEEE 802.11 technology) can exist simultaneously on a wireless device—e.g., a mobile smartphone can include both Wi-Fi and Bluetooth capabilities. However, this can cause self-interference. That is, co-located non-Wi-Fi radio technology does not follow the same channel access and transmission protocols as Wi-Fi technology radios. In some embodiments, the self-interference can affect an AP MLD's ongoing transmissions and receptions as a signal-to-interference-plus-noise-ratio (SINR) gets reduced and performance is degraded. In some examples, a device may not be able to transmit Wi-Fi frames while another coexisting radio technology is on and active within the device. For example, a device may include an antenna utilized by both Wi-Fi and Bluetooth. In some embodiments, if the device has the antenna utilized for Bluetooth, the device can be unavailable for Wi-Fi frame exchanges, and any frames sent during that time lead to failure and hurt the performance of the device.

In one embodiment, to address the interference to receptions on the Wi-Fi radio, one approach is to reduce a transmit opportunity (TXOP) dynamically such that the TXOP ends prior to a start of a co-existence event (e.g., before the start of the interference on the receptions of the Wi-Fi radio). In such embodiments, a transmitter (e.g., AP or STA) can transmit an initial control frame (ICF) and a responder can transmit an initial control response (ICR) frame. In theory, an exchange of the control frames can enable the transmitter to reduce its TXOP dynamically to end the TXOP prior to the start of the co-existence event.

However, conventional solutions fail to address the issue in practice. That is, a design of a new ICF and ICR frames for the exchange can be impractical as it leads to heavy implementation changes. Conventional ICF and ICR frames, though, do not support co-existence information exchange. Thus, current ICF and ICR frames can be enhanced. In one embodiment, a buffer status report poll (BSRP) frame can be used as an ICF frame and an enhanced multi-STA block acknowledgement (BA) containing co-existence information can be used as an ICR. However, conventional solutions utilize the BSRP frame to fetch a buffer status report (BSR) and not for multi-STA BA. Accordingly, when a responder receives an ICF frame that already exists in the baseline, the responder may not be able to distinguish between the BSRP frame meant as an ICF frame and a BSRP frame meant to fetch a BSR. In such embodiments, a procedure is needed by which the ICF can indicate which ICR can be sent as a response.

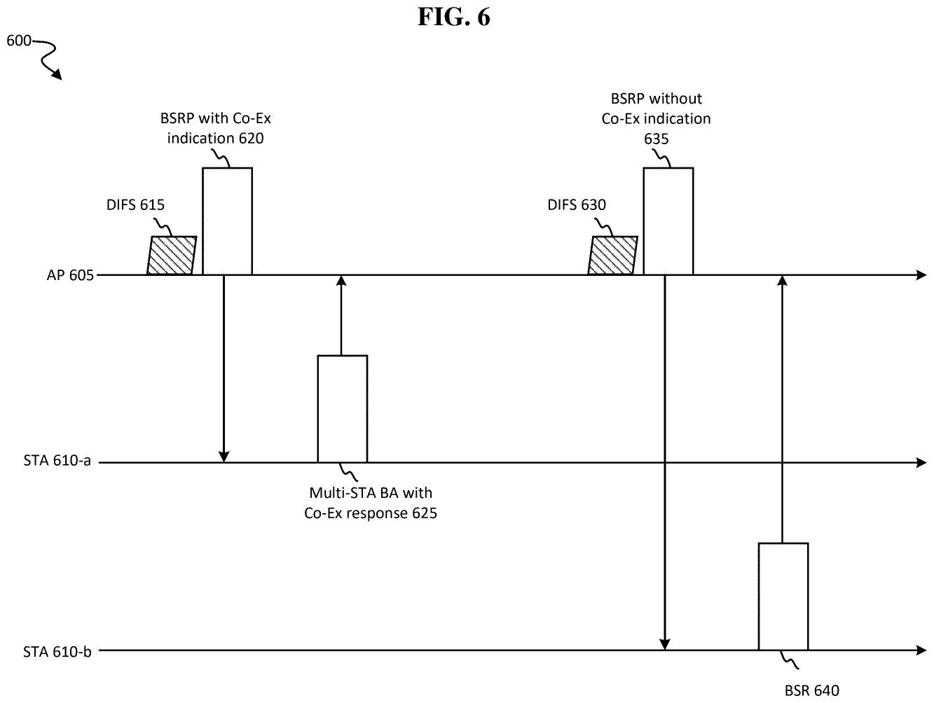

FIG. 6 shows an example co-existence control frame exchange 600 in accordance with an embodiment. Although one or more operations are described or shown in a particular sequential order, in other embodiments the operations may be rearranged in a different order, which may include performance of multiple operations in at least partially overlapping time periods. It should be noted that the co-existence session, co-existence mode, or the co-existence operations can be referred to as a dynamic unavailability operation (DUO). In some embodiments, co-existence can refer to any type of unavailability—e.g., the embodiments described herein apply to any kind of unavailability event information.

In at least one embodiment, process 600 is performed by an access point (AP) 605 and one or more stations (STASs) 610—e.g., station 610-a and station 610-b. In some embodiments, access points 605 and the STAs 610 are examples of AP 101 or AP 103 or STA 111, STA, 112, STA 113, or STA 114 as described with reference to FIG. 1, respectively.

In at least one embodiment, an AP 605 can transmit an initial control frame (ICF) that contains an indication message indicating a frame that an STA 610 can utilize for transmitting a response to the ICF—e.g., the ICF can indicate a format or a type of initial control response (ICR) that the STA 610 should transmit. In one embodiment, the ICF can include an indication message that includes at least one or more of the following information items listed in Table 1:

TABLE 1

| Information Items | Description |
|---|---|
| ICR indication | One or more information items that indicate |
| | what the ICR format or response should be- |
| | e.g., information items that indicate the |
| | information that can be carried in the ICR. Can |
| | be a bit/flag/encoding of bits that take a |
| | predetermined value (e.g., three (3)) to make |
| | an indication and another predetermined value |
| | (e.g., not three (3)) to indicate otherwise |
| Response Content | One or more information items that indicate |
| | what information is requested or expected in |
| | the ICR-e.g., timing information of the co- |
| | existence event or dynamic unavailability |
| | operation, frequency information of the co- |
| | existence event, etc. |

Accordingly, when an STA 610 receives an ICF from the AP 605, the STA 610 can check the ICR indication and determine an appropriate ICR to respond back to the AP 605.

For example, referring to FIG. 6, at operation 615, the AP 605 can be evaluating whether a channel is idle during a distributed coordination function interframe space (DIFS) interval. In one embodiment, the AP 605 can determine the channel is idle and proceed to operation 620.

At operation 620, the AP 605 can transmit a buffer status report poll (BSRP) frame to STA 610-a. In some embodiments, the STA 610-a can receive the BSRP and check the indication to determine the frame to respond with. In one embodiment, the BSRP frame can include a co-existence indication described with reference to Table 1. For example, the BSRP frame can include an indication that the BSRP frame is an ICF frame that expects or request unavailability information.

At operation 625, the STA 610-a can respond with a muti-station (STA) block acknowledgement (BA). In at least one embodiment, the STA 610-a can transmit the multi-STA BA with a co-existence response—e.g., with co-existence information. For example, the STA 610-a could indicate unavailability target start time (e.g., a time when the STA 610-a is unavailable), unavailability duration (e.g., how long the STA 610-a is unavailable for), the frequency, etc.

At operation 630, the AP 605 can again evaluate whether the channel is idle during the DIFS interval. In one embodiment, the AP 605 can determine the channel is idle and proceed to operation 635.

At operation 635, the AP 605 can transmit a BSRP frame to STA 610-b. In one embodiment, the BSRP frame transmitted during operation 635 does not include a co-existence indication (e.g., or includes a co-existence indication indicating the BSRP frame is not associated with requesting unavailability information). In one embodiment, the STA 610-b can receive the BSRP and determine the lack of the co-existence indication.

At operation 640, the STA 610-b can respond back to the AP 605 by transmitting a buffer status report (BSR) frame. That is, when the BSRP frame does not include the cp-existence indication (or indicates the BSRP frame is not associated with unavailability), the STA 610 can respond to the BSRP with the BSR frame. Accordingly, the AP 605 can utilize the BSRP frame to either receive BSR information from the STA 610 or the AP 605 can utilize the BSRP frame as an ICF frame and trigger unavailability information from the STA 610.

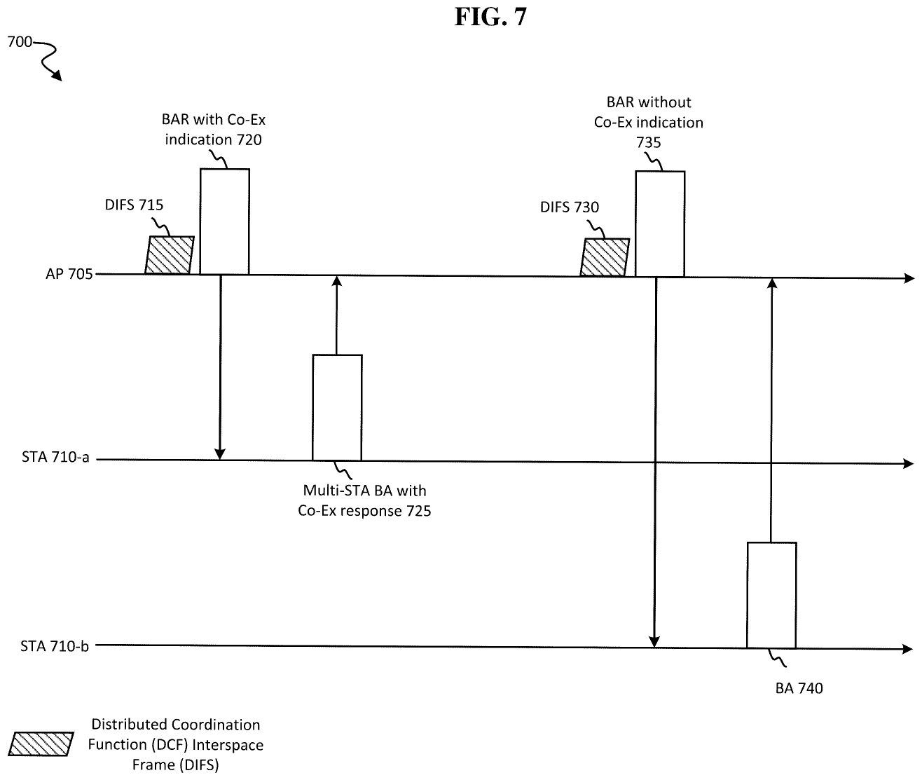

FIG. 7 shows an example co-existence control frame exchange 700 in accordance with an embodiment. Although one or more operations are described or shown in a particular sequential order, in other embodiments the operations may be rearranged in a different order, which may include performance of multiple operations in at least partially overlapping time periods. It should be noted that the co-existence session, co-existence mode, or the co-existence operations can be referred to as a dynamic unavailability operation (DUO). In some embodiments, co-existence can refer to any type of unavailability—e.g., the embodiments described herein apply to any kind of unavailability event information.

In at least one embodiment, process 700 is performed by an access point (AP) 705 and one or more stations (STAs) 710—e.g., station 710-a and station 710-b. In some embodiments, access points 705 and the STAs 710 are examples of AP 101 or AP 103 or STA 111, STA, 112, STA 113, or STA 114 as described with reference to FIG. 1, respectively. In one embodiment, process 700 is similar to process 600 as described with reference to FIG. 6 but using a block acknowledgement request (BAR) frame instead of the BSRP frame.

For example, at operation 715, the AP 705 can evaluate whether a channel is idle during a distributed coordination function interframe space (DIFS) interval. In one embodiment, the AP 705 can determine the channel is idle and proceed to operation 720.

At operation 720, the AP 705 can transmit a block acknowledgement request (BAR) frame to STA 710-a. In some embodiments, the STA 710-a can receive the BAR and check a co-existence indication to determine the frame to respond with. That is, the BAR frame can be modified to be utilized as an ICF frame with a co-existence indication. In one embodiment, the BAR frame can include a co-existence indication described with reference to Table 1. For example, the BAR frame can include an indication that the BAR frame is an ICF frame that expects or request unavailability information.

At operation 725, the STA 710-a can respond with a muti-station (STA) block acknowledgement (BA). In at least one embodiment, the STA 710-a can transmit the multi-STA BA with a co-existence response—e.g., with co-existence information. For example, the STA 710-a could indicate unavailability target start time (e.g., a time when the STA 710-a is unavailable), unavailability duration (e.g., how long the STA 710-a is unavailable for), the frequency, etc.

At operation 730, the AP 705 can again evaluate whether the channel is idle during the DIFS interval. In one embodiment, the AP 705 can determine if the channel is idle and proceed to operation 735.

At operation 735, the AP 705 can transmit a BAR frame to STA 710-b. In one embodiment, the BAR frame transmitted during operation 735 does not include a co-existence indication (e.g., or includes a co-existence indication indicating the BAR frame is not associated with requesting unavailability information). In one embodiment, the STA 710-b can receive the BAR and determine the lack of the co-existence indication.

At operation 740, the STA 710-b can respond back to the AP 705 by transmitting a block acknowledgment (BA) frame. That is, when the BAR frame does not include the cp-existence indication (or indicates the BAR frame is not associated with unavailability), the STA 710 can respond to the BAR with the BA frame. Accordingly, the AP 705 can utilize the BAR frame to either receive a BA from the STA 710 or the AP 705 can utilize the BAR frame as an ICF frame and trigger unavailability information from the STA 710.

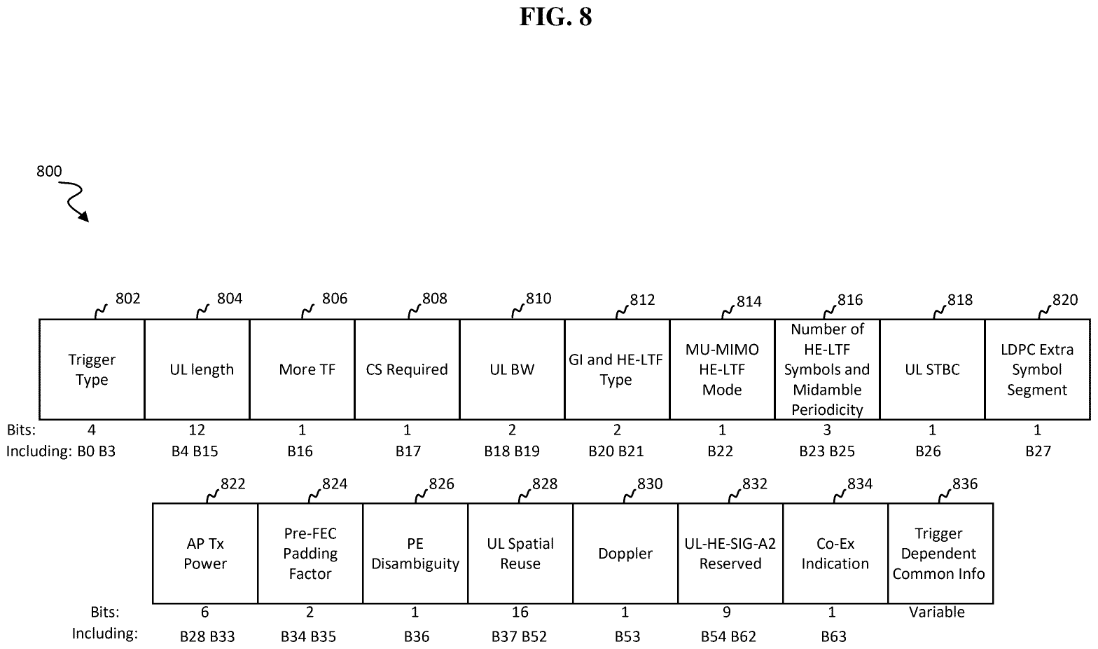

FIG. 8 illustrates an example common information field 800 including a co-existence indication in accordance with an embodiment herein. The format depicted in FIG. 8 is for explanatory purposes only. FIG. 8 does not limit the scope of this disclosure to any particular embodiment. In some embodiments, the common information field 800 is transmitted by an Access Point (AP) to a station (STA).

In one embodiment, the common information field 800 shown is for a buffer status report poll (BSRP) frame. In one embodiment, the BSRP trigger frame triggers an uplink response from one or more multi-user (MU) capable STAs that are addressed by the BSRP trigger frame via orthogonal frequency-division multiple access (OFDMA). In at least one example, a response to the BSRP trigger frame includes an uplink Buffer Status Report (BSR) corresponding to different traffic categories at the responding STAs. In some cases, the STA response is useful for the triggering device (e.g., an AP) to subsequently assign uplink resources for the responding STAs for their trigger-based uplink transmissions. In other embodiments, the BSRP trigger frame triggers unavailability information reporting from one or more STAs. In such embodiments, the BSRP trigger frame can indicate the request for the unavailability information within the common information field as described herein.

In one embodiment, a format of the common information field 800 for a BSRP trigger frame is illustrated with reference to FIG. 8. For example, the common information field 800 can include a trigger type subfield 802, a UL length subfield 804, a more trigger frames (TF) subfield 806, a carrier sense (CS) required subfield 808, an uplink bandwidth (UL BW) subfield 810, a guard interval (GI) and high efficiency (HE)-long training field (LTF) type subfield 812, a multi-user multiple-input multiple-output (MU-MIMO) HE-LTF mode subfield 814, a number of HE-LTF symbols and midamble periodicity subfield 816, a UL space-time block coding (STBC) subfield 818, a low-density parity-check (LDPC) extra symbol segment subfield 820, an AP transmitting (Tx) power subfield 822, a pre-forward error correction (pre-FEC) padding factor subfield 824, a packet extension (PE) disambiguity subfield 826, a UL spatial reuse 828, a doppler subfield 830, a UL-HE-SIG-A2 (High efficiency signal A2) subfield 832, a co-existence indication subfield 834, and trigger dependent common information subfield 836.

In one embodiment the trigger type subfield 802 can indicate a type of trigger frame the common information field 800 is associated with. For example a trigger subfield 805 having a value four (4) can be associated with the BSRP trigger frame. In other embodiments, the trigger type 802 could indicate a different type of trigger frame (e.g., a value zero ‘0’ can indicate a basic trigger frame, a value one ‘1’ can indicate a beamforming report poll (BFPR) trigger frame, a value two ‘2’ can indicate a multi-user (MU) block acknowledgment request (BAR) trigger frame, etc.). In at least one embodiment, uplink length (UL) subfield 804 can indicate a desired length of a response frame to the BSRP trigger frame. In at least one embodiment, when the BSRP trigger frame is utilized to trigger unavailability information, the BSRP trigger frame can include a UL length subfield 804 having a value that is sufficiently large enough to allow the STA to include in the physical layer protocol data unit (PPDU) that is sent in response to an initial ICR that can include unavailability information. In one embodiment, the UL length subfield 804 can indicate why type of ICR format to utilize. For example, if the UL length subfield 804 is set to a value that sufficiently covers a length of a multi-STA BA along with a BSR, then the STA can transmit both the multi-STA BA and the BSR. In other embodiments, if the UL length subfield 804 is set to a value that is sufficient to cover the Multi-STA BA unavailability report but not the BSR, then the STA can transmit just the unavailability report. In one embodiment, if the UL length subfield 804 is set to a value that is sufficient to cover the BSR but not the multi-STA BA unavailability report, the STA can transmit just the BSR.

In one embodiment, a more trigger frames (TF) subfield 806 indicates whether a subsequent trigger frame is scheduled for transmission. In at least one embodiment, the CS required subfield 808 indicates that STAs identified in a user information field that should use energy detect (ED) to sense a medium before sending a response frame if the CS required subfield 808 is set to one ‘1’. In some cases, the UL BW subfield 810 describes a bandwidth to be used for the transmission of the response to the common information field 800 (e.g., the trigger frame carrying the common information field 800). In some embodiments, the GI and HE-LTF type subfield 812 sets the GI and LTF type for the HE variant common information field. In one embodiment, the co-existence indication discussed with reference to FIG. 6 can be included in the GI and HE-LTF type subfield 812. For example, the GI and HE-LTF type subfield 812 can be a 2 bit field that indicates if a responding PPDU format is non-high throughput (HT) PPDU format that contains a multi-STA block acknowledgement. In one embodiment, the GI and HE-LTF type subfield 812 can be set to a value three ‘3’ to indicate that the response should be a multi-STA BA. In one embodiment, an encoding for the GI and HE-LTF type subfield 812 is provided by the following Table (Table 2):

TABLE 2

| GI and HE/Extremely | |
|---|---|
| High Throughput | |
| (EHT)/Ultra-high | |
| reliability | |
| (UHR)-LTF subfield | |
| 812 value | Description |
| 0 | 1x HE/EHT/UHR-LTF + 1.6 μs GI |
| 1 | 2x HE/EHT/UHR-LTF + 1.6 μs GI |
| 2 | 4x HE/EHT/UHR-LTF + 1.6 μs GI |
| 3 | The responding PPDU format is non-HT |
| | (duplicate) PPDU format that contains |
| | a Multi-STA Block Acknowledgement |

Accordingly, in such examples, if the GI and HE/EHT/UHR-LTF subfield 812 is set to a three ‘3’ the STA can respond with a multi-STA block acknowledgment frame and if the GI and HE/EHT/UHR-LTF subfield 812 is set to anything other than three ‘3,’ then the PPDU sent in response to the BSRP trigger frame uses a trigger-based PPDU format. In some embodiments, the MU-MIMO HE-LTF mode subfield 814 indicates a HE-LTF mode for an HE trigger based (TB) physical layer protocol data unit (PPDU) that has a resource unit (RU) that spans an entire bandwidth that is assigned to more than one non-AP STA. In some examples, the number of HE-LTF symbols and midamble periodicity subfield 816 sets a number of LTF symbols present in the common information field 800. In one or more embodiments, the UL STBC subfield 818 indicates a status of STBC encoding for solicited HE TB PPDUs. In some embodiments, the LDPC extra symbols subfield 820 indicates a status of the LDPC extra symbol segment—e.g., a value one (1) indicates that the LDPC extra symbol segment is present and a value zero (0) indicates that the LDPC extra symbol segment is not present. In some embodiments, the AP Tx power field subfield 822 indicates the AP's combined transmit power at a transmit antenna connector of all antennas used to transmit the triggering PPDU. In some embodiments, the pre-FEC padding factor subfield 824 and the PE disambiguity subfield 826 set a packet extension duration. That is, a first two bits indicate the pre-FEC padding factor and a third bit indicates the PE-disambiguity. In at least one embodiment, a UL spatial reuse subfield 828 set a value for the spatial reuse field in the HE-SIG-A field. In one or more embodiments, the doppler subfield 830 indicates whether a preamble is present—e.g., a value one (1) indicates that a midamble is present and a value zero (0) indicates that the midamble is not present. In some embodiments, the UL-HE-SIG-A2 reserved subfield 832 carries a value to be included in a reserved field of the HE-SIG-A2 subfield.

In one embodiment, co-existence indication 834 can be an indication that indicates whether the common information field 800 of the BSRP trigger frame is associated with a BSR or a multi-STA BA response. For example, if a co-existence indication subfield 834 is set to one ‘1’, than the STA can respond with a multi-STA BA. In other embodiments, if the co-existence indication subfield 834 is set to zero ‘0’, the STA can respond with a BSR. In other embodiments, the trigger type subfield 802 can also indicate if the BSRP trigger frame is a mutli-STA BA fetching BSRP trigger frame or a normal trigger frame asking for the BSR. In one embodiment, the common information field 800 can include trigger dependent common information 836.

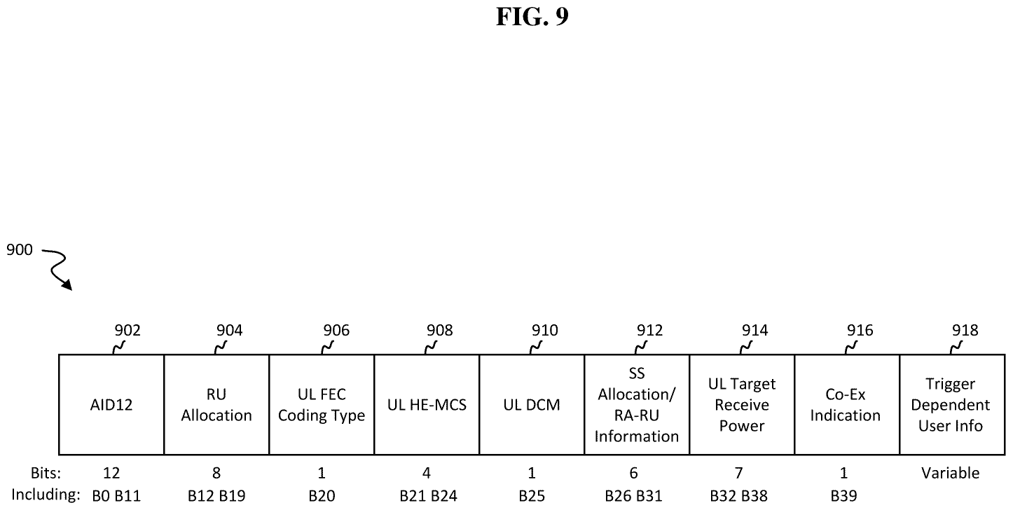

FIG. 9 illustrates an example user information field 900 including a co-existence indication in accordance with an embodiment herein. The format depicted in FIG. 9 is for explanatory purposes only. FIG. 9 does not limit the scope of this disclosure to any particular embodiment. In some embodiments, the user information field 900 is transmitted by an Access Point (AP) to a station (STA). In one embodiment, the user information field 900 is a user information field of a BSRP trigger frame.

For example, each addressed STA by the BSRP trigger frame has a corresponding user information field 900 in the BSRP trigger frame and the resource units (RU) allocation field 904 of the user information field 900 indicates a set of RUs on which the STA is expected to transmit the response frame on. In at least one embodiment, when the STA does respond to a BSRP trigger frame, the STA is expected to ensure that a start time of the response frame is within ±0.4 microseconds (μs)+16 μs from an end, at the STA's transmit antenna connector, of the last OFDM symbol of the triggering PPDU (e.g., if the triggering PPDU contains no packet extension (PE) field) or of the PE field of the triggering PPDU (e.g., if the PE field is present). In some embodiments, the responding STA is also required to compensate for carrier frequency offset (CFO) errors and symbol clock errors with respect to the triggering PPDU when transmitting the response. In some embodiments, the residual CFO after correction can below 300 hertz (Hz) for an BSRP trigger frame.

In one embodiment, the user information field 900 can include an include an association identification (AID12) subfield 902, a resource unit (RU) allocation subfield 904, an uplink forward error correction (UL FEC) coding type subfield 906, a UL HE modulation and coding scheme (HE-MCS) subfield 908, a UL dual carrier modulation (DCM) subfield 910, a spatial stream (SS) allocation/random access resource unit (RA-RU) information subfield 912, a UL target receive power subfield 914, a co-existence indication subfield 916, and/or trigger dependent user information subfield 918. In one embodiment, the AID12 subfield 902 identifies the STA the user information field is addressed to. In one embodiment, RU allocation subfield 904 depends on a size of a channel width. In some embodiments, the RU allocation subfield 904 depends on a value of the UL bandwidth subfield 810 of the common information field 800. For example, the RU allocation subfield 904 can have a bit have a value zero ‘0’ when the UL BW subfield 810 indicates 20 megahertz (MHz), 40 MHz, or 80 MHz PPDU. In at least one embodiment, the UL FEC coding type subfield 906 indicates a code type of the solicited HE TB PPDU. In some embodiments, the UL FEC coding type subfield 906 is set to zero ‘0’ to indicate a block check character (BCC) and is set to one ‘1’ to indicate a low-density parity-check (LDPC) code. In one or more embodiments, the UL-HE-MCS subfield 908 indicates a HE-MCS of the solicited HE TB PPDU. In at least one embodiment, the UL DCM subfield 910 indicates the DCM of the solicited HE TB PPDU. For example, the UL DCM subfield 910 is set to one ‘1’ if the DCM is used and is set to zero ‘0’ to indicate the DCM is not used. In some embodiments, the UL DCM subfield 910 is set to zero ‘0’ if the UL SBTC subfield 818 is set to one ‘1’. In some embodiments, the SS allocation and RA-RU information subfield 912 can indicate a spatial stream of the solicited HE TB PPDU and the format. In some embodiments, the UL target receive power subfield 914 can indicate an expected receive signal power, measured at the AP's antenna connector and averaged over the antennas. In some embodiments, the user information field 800 can include a co-existence indication subfield 916. In one embodiment, the co-existence indication subfield 916 can indicate whether the BSRP trigger frame is to be responded to with a Multi-STA BA or a BSR. For example, if the co-existence indication subfield 916 is set to one ‘1’ then the STA can respond with a multi-STA BA. In such examples, if the co-existence indication subfield 916 is set to zero ‘0’, the STA can respond with a BSR. It should be noted that the values described herein are examples and other values are possible. In some examples, the user information field 900 may not include the co-existence indication 916 or the trigger dependent information 918.

Additionally, there can be multiple indications that can be provided in the co-existence indication 916 (e.g., or co-existence indication 834). For example, the following table (Table 3) lists possible ICR or co-existence indications the AP can provide to the STA:

TABLE 3

| Type of Indication | Description |
|---|---|
| Indication of whether to | The AP can indicate in the ICF frame whether |
| send a BSR or not in | it expects the STA to report a BSR in the ICR |
| the ICR frame | or not |
| Sending unavailability | The AP can indicate in the ICF frame whether |
| feedback or not | it expects the STA to report unavailability |
| | information or not in the ICR |
| Indication of a type | The AP can indicate in the ICF the exact |
| of information requested | information or content of the feedback it |
| by the AP | expects the STA to report in the ICR-e.g., via |
| | an encoding to indicate the content of the ICR |

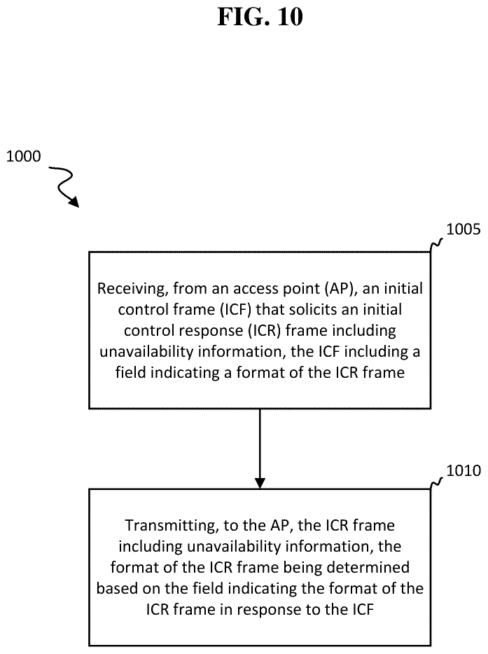

FIG. 10 shows an example process 1000 for control frame exchanges for co-existence or unavailability operations in accordance with an embodiment. For explanatory and illustration purposes, the process 1000 may be performed by an access point (AP) and station (STA) as described with reference to FIGS. 6-9. Although one or more operations are described or shown in a particular sequential order, in other embodiments the operations may be rearranged in a different order, which may include performance of multiple operations in at least partially overlapping time periods.

Referring to FIG. 10, the process 1000 may begin in operation 1005. At operation 1005, a station (STA) (e.g., a processor of the STA can cause) receives, from an access point (AP), an initial control frame (ICF) that solicits an initial control response (ICR) frame including unavailability information, the ICF including a field indicating a format of the ICR frame. In an embodiment, the ICF is a buffer status report poll (BSRP) trigger frame. In an embodiment, the unavailability information is one or more of associated with in-device coexistence, timing information of the in-device coexistence, or frequency information of the in-device coexistence—e.g., the ICF frame can request the information indicated in Table 1 above. In one embodiment, the ICF includes a common information field and one or more user information fields, the common information field providing information that is common to one or more recipients, and each user information field providing information that is specific to a corresponding recipient, the field indicating the format of the ICR frame is included in the common information field, and a user information field includes an identifier that addresses the STA. In one embodiment, the STA can be addressed individually—e.g., the ICF includes a single user information field addressed to the STA or each user information field of the ICF addresses the STA. In other embodiments, the STA can be addressed by its 12 least significant bits (LSB) within the user information field of the one or more user information fields. In an embodiment, the field having a first value indicates a first format of the ICR frame soliciting the unavailability information and the field having a second value indicates a second format of the ICR soliciting a buffer status report of the STA. That is, the ICF can solicit unavailability information, or a buffer status report based on a type of BSRP trigger frame transmitted as described with reference to FIG. 6.

At operation 1010, the STA can transmit, to the AP, the ICR frame including unavailability information, the format of the ICR frame being determined based on the field indicating the format of the ICR frame in response to the ICF. In an embodiment, the ICR frame is a multi-STA block acknowledgment (BA) frame. In an embodiment, the multi-STA BA frame includes the unavailability information and a buffer status report of the STA. In that, as described above, the STA can transmit both the unavailability information and the buffer status report when in a co-existence session (e.g., unavailability session) with the AP.

By using a co-existence indication, the AP can repurpose BSRP frames as initial control frames to solicit unavailability information from the STA to reduce interference in the overall wireless system.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
receiving, from an access point (AP), an initial control frame (ICF) that solicits an initial control response (ICR) frame including unavailability information, the ICF including a field indicating a format of the ICR frame; and
transmitting, to the AP, the ICR frame including unavailability information, the format of the ICR frame being determined based on the field indicating the format of the ICR frame in response to the ICF.

2. The STA of claim 1, wherein the ICF is a buffer status report poll (BSRP) trigger frame.

3. The STA of claim 1, wherein the ICR frame is a multi-STA block acknowledgment (BA) frame.

4. The STA of claim 3, wherein the multi-STA BA frame includes the unavailability information and a buffer status report of the STA.

5. The STA of claim 4, wherein the processor is configured to transmit the multi-STA BA frame including the unavailability information and the buffer status report of the STA based on an unavailability session with the AP.

6. The STA of claim 1, wherein the unavailability information is one or more of associated with in-device coexistence, timing information of the in-device coexistence, or frequency information of the in-device coexistence.

7. The STA of claim 1, wherein:
the ICF includes a common information field and one or more user information fields, the common information field providing information that is common to one or more recipients, and each user information field providing information that is specific to a corresponding recipient;
the field indicating the format of the ICR frame is included in the common information field; and
a user information field includes an identifier that addresses the STA.

8. The STA of claim 1, wherein:
the field having a first value indicates a first format of the ICR frame soliciting the unavailability information; and
the field having a second value indicates a second format of the ICR soliciting a buffer status report of the STA.

9. An access point (AP) in a wireless network, comprising:
a memory; and
a processor coupled to the memory, the processor configured to cause:
transmitting, to one or more stations (STAs), an initial control frame (ICF) that solicits one or more initial control response (ICR) frames including unavailability information, the ICF including a field indicating a format of the one or more ICR frames; and
receiving, from at least one STA, an ICR frame including unavailability information, the format of the ICR frame being determined based on the field indicating the format of the ICR frame in response to the ICF.

10. The AP of claim 9, wherein the ICF is a buffer status report poll (BSRP) trigger frame.

11. The AP of claim 9, wherein the ICR frame is a multi-STA block acknowledgment agreement (BA) frame.

12. The AP of claim 11, wherein the multi-STA BA frame includes the unavailability information and a buffer status report of the at least one STA.

13. The AP of claim 12, wherein the processor is configured to receive the multi-STA BA frame including the unavailability information and the buffer status report of the at least one STA based on an unavailability session with the AP.

14. The AP of claim 9, wherein the unavailability information is one or more of associated with in-device coexistence, timing information of the in-device coexistence, or frequency information of the in-device coexistence.

15. The AP of claim 9, wherein:
the ICF includes a common information field and one or more user information fields, the common information field providing information that is common to the one or more STAs, and each user information field providing information that is specific to a corresponding STA of the one or more STAs;
the field indicating the format of the ICR frame is included in the common information field; and
each user information field includes an identifier that addresses the corresponding STA.

16. The AP of claim 1, wherein:
the field having a first value indicates a first format of the ICR frame soliciting the unavailability information; and
the field having a second value indicates a second format of the ICR frame soliciting a buffer status report of the STA.

17. A method performed by a station (STA) in a wireless network, comprising:
receiving, from an access point (AP), an initial control frame (ICF) that solicits an initial control response (ICR) frame including unavailability information, the ICF including a field indicating a format of the ICR frame; and
transmitting, to the AP, the ICR frame including unavailability information, the format of the ICR frame being determined based on the field indicating the format of the ICR frame in response to the ICF.

18. The method of claim 17, wherein the ICF is a buffer status report poll (BSRP) trigger frame.

19. The method of claim 17, wherein the ICR frame is a multi-STA block acknowledgment (BA) frame.

20. The method of claim 19, wherein the multi-STA BA frame includes the unavailability information and a buffer status report of the STA.
